(19) United States
(12) Patent Application Publication
(10) Pub. No.: US 2023/0016319 A1
(43) Pub. Date: Jan. 19, 2023

(54) POSITIVE ELECTRODE FOR LITHIUM ION SECONDARY BATTERY AND LITHIUM ION SECONDARY BATTERY

(71) Applicant: The Furukawa Battery Co., Ltd., Yokohama-shi (JP)

(72) Inventor: Naoki Takeguchi, Iwaki-shi (JP)

(73) Assignee: The Furukawa Battery Co., Ltd., Yokohama-shi (JP)

(21) Appl. No.: 17/860,702

(22) Filed: Jul. 8, 2022

(30) Foreign Application Priority Data
Jul. 9, 2021 (JP) 2021-114373

(51) Int. Cl. H01M 4/36; H01M 10/0525; H01M 4/505; H01M 4/525

(52) U.S. Cl. CPC H01M 4/364; H01M 10/0525; H01M 4/505; H01M 4/525; H01M 2004/028

(57) ABSTRACT

A positive electrode for a lithium ion secondary battery includes a positive electrode current collector and a positive electrode mixture layer formed on one surface or both surfaces of the positive electrode current collector, wherein the positive electrode mixture layer contains a positive electrode active material, and conductive agent material, and a binder, the positive electrode active material is a mixture of a first positive electrode active material which is a lithium composite oxide with a layered structure and a second positive electrode material which is a polyanionic compound with an olivine type structure.

### CROSS-REFERENCE TO RELATED APPLICATION

This application is based upon and claims the benefit of priority from prior Japanese Patent Application No. 2021-114373 filed on Jul. 9, 2021, the entire contents of which are incorporated herein by reference.

### FIELD

The present disclosure relates to a positive electrode for a lithium ion secondary battery and a lithium ion secondary battery.

### BACKGROUND

In recent years, lithium ion secondary batteries are widely used as small power sources for mobile phones and clamshell personal computers or as large batteries for electronic vehicles. While demands for the lithium ion secondary batteries are increasing, higher energy density is required. Furthermore, the lithium ion secondary batteries may generate heat, and thus, higher security is also required as with the higher energy density requirement.

Positive electrodes for the lithium ion secondary battery are formed of a lithium composite oxide with a layered structure such as LiCoO2, or LiNiO2, which functions at a high potential in consideration of the high energy density. On the other hand, polyanionic compounds containing olivine type lithium such as LiFePO₄ with a high thermal stability will be used in consideration of the high security.

From the above standpoint, JP 6607388 B discloses a positive electrode including a positive electrode mixture layer containing a positive electrode active material which is mixture of a lithium composite oxide with a layered structure having a high energy density and a polyanionic compound having a high thermal stability.

Furthermore, JP 2020-512669 A discloses a positive electrode including a two-layered structure positive electrode mixture layer in which a first positive electrode mixture layer and a second positive electrode mixture layer are formed on a positive electrode current controller (for example, aluminum foil). The first and second positive electrode mixture layer include different positive electrode active material from each other. In such a positive electrode, when the lithium composite oxide with a layered structure having a high energy density is used in the first positive electrode mixture layer as a positive electrode active material, and a polyanionic compound having a high thermal stability is used in the second positive electrode mixture layer as a positive electrode active material, and thereby, both the high security and high energy density can be achieved.

### SUMMARY

In JP 6607388 B, the lithium composite oxide with the layered structure which is one positive electrode active material contained in the positive electrode mixture layer has the high energy density. However, the lithium composite oxide may possibly be a heat generation phenomenon according to a reaction between oxygen and non-aqueous electrolyte at a high temperature period caused by the influence of a phase change by oxygen desorption in a high potential side. That is a problem from the security standpoint. On the other hand, the polyanionic compound as the other positive electrode active material has the high security. However, the energy density thereof is small. As a result, the positive electrode including the positive electrode mixture layer containing the positive electrode active material in which is a mixture of the two types of positive electrode active materials shows a tradeoff relationship between the high security and the high energy density, which makes the achievement of both the high security and the high energy density difficult.

Furthermore, in JP 2020-512669 A, as the positive electrode includes the first and second positive electrode mixture layer which each contain different positive electrode active materials and binders, it which makes the manufacturing method thereof difficult. That is, in the making of the two layered structure positive electrode mixture layer, the first and second positive electrode mixture layers are formed by applying a slurry containing the positive electrode active materials and binders to the positive electrode current collector and drying the same. Therefore, the making of the first and second positive electrode mixture layers each containing the positive electrode active materials and the binders (the two layered structure positive electrode mixture layer) takes twice the time as compared to the making of one layer (single layer) positive electrode mixture layer. Furthermore, in general, the positive electrode mixture layer incorporated into the lithium ion secondary battery is a thin layer of a few tens μm, and thus, it is very difficult to evenly apply a two layered positive electrode mixture layer to the positive electrode current collector. Thus, productivity of the positive electrode including the two layered structure positive electrode mixture layer becomes low.

The present disclosure is provided a positive electrode for a lithium ion secondary battery including a single positive electrode mixture layer containing a mixture of a first positive electrode active material being a lithium composite oxide with a layered structure and a second positive electrode active material being a polyanionic compound with an olivine type structure as a positive electrode active material, which can achieve both high security and high energy density, and which can significantly increase production efficiency as compared to a positive electrode in which a positive electrode mixture layer with a two layered structure is formed on a positive electrode current collector.

A positive electrode for a lithium ion secondary battery of the present disclosure comprises a positive electrode current collector and a positive electrode mixture layer formed on one surface or both surfaces of the positive electrode current collector. The positive electrode mixture layer contains a positive electrode active material, a conductive agent, and a binder. The positive electrode active material is a mixture of a first positive electrode active material which is a lithium composite oxide with a layered structure and a second positive electrode material which is a polyanionic compound with an olivine type structure. An average secondary particle diameter of the first positive electrode active material is r1, and an average secondary particle diameter of the second positive electrode active material is r2, a relationship r1>r2 is satisfied. when an area occupation ratio of the second positive electrode active material on the surface of the positive electrode mixture layer is a in percentage, a weight ratio of the first positive electrode active material and the second positive electrode active material is given 100−β:β(0<β<100), and a relationship the α and the β is γ=β/α, the γ is 0.33 or more and 0.84 or less.

According to the present application, a positive electrode for a lithium ion secondary battery which can achieve both the high security and the high energy density, and which can improve wherein the production efficiency thereof is improved as compared to a positive electrode with a two layered structure positive electrode mixture layer.

Additional objects and advantages of the disclosure will be set forth in the description which follows, and in part will be obvious from the description, or may be learned by practice of the disclosure. The objects and advantages of the disclosure may be realized and obtained by means of the instrumentalities and combinations particularly pointed out hereinafter.

### DRAWINGS

The accompanying drawings, which are incorporated in and constitute a part of the specification, illustrate embodiments of the disclosure, and together with the general description given above and the detailed description of the embodiments given below, serve to explain the principles of the disclosure.

FIG. 1 shows a perspective view illustrating an example of a lithium ion secondary battery of a second embodiment.

FIG. 2 shows a cross-sectional view of the lithium ion secondary battery of FIG. 1, taken along line II-II.

### DETAILED DESCRIPTION

Hereinafter, embodiments of the present application will be explained; however, the present disclosure is not limited to the following description. Furthermore, various changes or modifications can be applied to the embodiments, and models with such changes and modifications will be encompassed within the scope of the present disclosure.

### First Embodiment

The lithium secondary battery positive electrode of the first embodiment includes a positive electrode current collector and a positive electrode mixture layer formed on one or both surfaces of the positive electrode current collector. The positive electrode mixture layer contains a positive electrode active material, conductive agent, and binder.

There are no restrictions on the material used to form the positive electrode current collector, but it is preferably a metal. Specifically, aluminum, nickel, stainless steel, titanium, and other alloys are examples. Aluminum is particularly preferred because of its high electronic conductivity and battery operating potential.

The positive electrode active material in the positive electrode mixture layer is a mixture of a first positive electrode active material which is a composite lithium oxide with a layered structure and a second positive electrode active material which is a polyanionic compound with an olivine type structure.

The first positive electrode active material, which is a composite lithium oxide with a layered structure, for example a layered rock salt type structure, is represented by general formula LiₐM1O₂ where M1 is at least one transition metal selected from the group consisting of Co, Ni, Mn, and Al, and a is 0.9≤a≤1.1. Preferred composite lithium oxides will be represented by general formula LiCoₓNi_{y}Mn_{z}O₂ (x+y+z=1).

The second positive electrode active material which is a polyanionic compound with olivine type structure, is represented by general formula Li_{b}M2PO₄ where M2 is at least one transition metal selected from the group consisting of Fe and Mn, and b is 0.9≤b≤1.1. Preferred polyanionic compounds are LiFe_{q}MnᵣPO₄ (q+r=1).

When the average secondary particle diameter of the first positive electrode active material is r1 and the average secondary particle diameter of the second positive electrode active material is r2, a relationship r1>r2 is satisfied. By satisfying such a relationship of average secondary particle diameters r1 and r2, the second positive electrode active material can be more present on the surface of the positive electrode mixture layer (surface opposite to the surface in contact with the positive electrode current collector).

In the above relationship of r1>r2, it is preferably that the average secondary particle diameter (r1) of the first positive electrode active material is 9 μm or more and 15 μm or less. When the average secondary particle diameter (r1) of the first positive electrode active material is between 9 μm or more and 15 μm or less, it is more preferably that the average secondary particle diameter (r2) of the second positive electrode active material is 2 μm or more and 8 μm or less. By specifying the average secondary particle diameters r1 and r2 of the first and second positive electrode active materials in this manner, it is possible to be present more of the second positive electrode active material on the surface of the positive electrode mixture layer (surface opposite to the surface in contact with the positive electrode current collector). More preferred average secondary particle diameter (r1) of the first positive electrode active material is 10 μm or more and 12 μm or less. More preferred average secondary particle diameter (r2) of the second preferred positive electrode active material is 5 μm or more and 7 μm or less.

In the first embodiment, the average secondary particle diameter of the positive electrode active material refers to a value measured by the following method (laser diffraction scattering method). That is, a laser diffraction particle size analyzer (model number: LA-950, manufactured by HORIBA, Ltd.) is used, 0.1 g of the secondary particles of the positive electrode active material is added to 50 ml of 0.2 mass % aqueous sodium hexametaphosphate aqueous solution. The secondary particles are dispersed therein to prepare a dispersion. The particle size distribution of the dispersion is measured to obtain a cumulative particle size distribution curve on a volume basis. In the cumulative particle size distribution curve obtained, the value of the particle diameter (D50) viewed from the microparticle side at the time of 50% accumulation is set to the average secondary particle diameter of the positive electrode active material.

In the first embedment, the area occupation ratio of the second positive electrode active material on the surface of the positive electrode mixture layer is expressed as a percentage a, the weight ratio of the first positive electrode active material to the second positive electrode active material is 100−β:β(0<β<100), and the relationship between α and β is γ=β/α, γ is 0.33 or more and 0.84 or less. The area occupation ratio α (expressed as a percentage) of the second positive electrode active material on the surface of the positive electrode mixture layer is represented in the following formula, where the area of the first positive electrode active material on the surface of the positive electrode mixture layer is a1, and the area of the second positive electrode active material on the surface of the positive electrode mixture layer is a2,

α=[a2/(a1+a2)]×100.

The surface condition of the positive electrode mixture layer (area occupation ratio of the second positive electrode active material) can be confirmed by scanning electron microscopy (SEM, EDS) observation. From the SEM observation, the average secondary particle diameter of the first positive electrode active material and the second positive electrode active material can be measured. Furthermore, from the EDS observation, the elemental mapping of the first and second positive electrode active materials on the surface of the positive electrode mixture layer can be performed. From the obtained EDS elemental mapping image, parts where the contrast of the element of the second positive electrode active material on the surface of the positive electrode mixture layer (e.g., Fe) is high can be selected by image analysis software, and thus, the area occupation ratio (α: percentage) of the second positive electrode active material on the surface of the positive electrode mixture layer can be calculated.

In the above formula γ=β/α, a change in a is mainly governed by a value of β, but is increased by another factor, namely r1>r2. A change in γ depends more on the value of β than on the value of α.

When γ is less than 0.33, the ratio of the first positive electrode active material in the positive electrode mixture layer increases, which allows for higher energy density, but the area occupation ratio of the second positive electrode active material on the surface of the positive electrode mixture layer will decrease, and security cannot be guaranteed. On the other hand, if γ exceeds 0.84, the area occupation ratio of the second positive electrode active material on the surface of the positive electrode mixture layer increases, which allows for ensured security, but the ratio of the first positive electrode active material in the positive electrode mixture layer will decrease, resulting in a loss of high energy density. The more preferred γ is 0.33 or more and 0.64 or less.

The conductive agent included in the positive electrode mixture layer is, for example, one selected from the group consisting of conductive carbon powders such as graphite and carbon black, carbon nanotubes, carbon nanofibers, and graphene, or a mixture of two or more of the above.

The binder in the positive electrode mixture material is, for example, one selected from the group consisting of polyethylene, polypropylene, ethylene-propylene terpolymer, butadiene rubber, styrene-butadiene rubber, butyl rubber, polytetrafluoroethylene, poly(meth)acrylate, polyvinylidene fluoride, polyethylene oxide, polypropylene oxide, polyepichlorohydrin, polyphosphazene, and polyacrylonitrile, or a mixture of two or more of the above.

The positive electrode of the first embedment can be produced by the following method.

First, the first positive electrode active material, which is a lithium composite oxide with a layered structure having a high energy density, and the second positive electrode active material, which comprise a polyanionic compound with high thermal stability are prepared. A conductive agent and a binder are added to the first and second positive electrode active materials, and are dispersed in a solvent such as N-methyl-2-pyrrolidone, N,N-dimethylformamide, and N,N-dimethylacetamide, to prepare a positive electrode slurry. The positive electrode slurry is applied to one or both surfaces of the positive electrode current collector, dried to form the positive electrode mixture layer, and if necessary, the positive electrode mixture layer is pressed to produce the positive electrode.

In the drying process during the production of the positive electrode, when the average secondary particle diameters of the first and second positive electrode active materials are given r1 and r2, respectively, the average secondary particle diameters of the first and second positive electrode active materials are selected so as to satisfy the relationship r1>r2, the second positive electrode active material having a smaller average secondary particle diameter than that of the first positive electrode active material in the positive electrode mixture layer migrates toward the surface (front surface) opposite to the surface in contact with the positive electrode current collector. The migration causes more of the secondary positive electrode active material to be present on the front surface of the positive electrode mixture layer. As a result, in general, the area occupation ratio of the second positive electrode active material on the front surface of the positive electrode mixture layer, i.e., the surface in contact with the non-aqueous electrolyte depends on the proportion of the second positive electrode active material in positive electrode mixture layer. When the proportion thereof is increased, the area occupation ratio of the second positive electrode active material increases, and when the proportion thereof is decreased, the area occupation ratio of the second positive electrode active material decreases. In contrast, by selecting the average secondary particle diameter of the first and second positive electrode active materials such that the relationship r1>r2 is satisfied, can increase the area occupation ratio of the secondary positive electrode active material on the front surface of the positive electrode mixture layer. It is attributed to a factor other than the proportion of the second positive electrode active material in the positive electrode mixture layer, i.e., the migration of the second positive electrode active material.

Therefore, by the method described above, the positive electrode which satisfies the relationship of r1>r2 of the average secondary particle diameter (r1, r2) of the first and second positive electrode active materials, and the aforementioned γ (α/β) is 0.33 or more and 0.84 or less, inclusive can be obtained.

According to the first embodiment described above, the relationship between the average secondary particle diameter (r1) of the first positive electrode active material and the average secondary particle diameter (r2) of the second positive electrode active material is satisfied as r1>r2. Furthermore, when the area occupation ratio of the second positive electrode active material on the surface of the positive electrode mixture layer is expressed as a as percentage, the weight ratio of the first positive electrode active material to the second positive electrode active material is 100−β:β(0<β<100), and the relationship between α and β is γ=β/α, γ is defined in a range 0.33 or more and 0.84 or less. Thereby, the proportion of the first positive electrode active material in the positive electrode mixture layer is increased and a high energy density is ensured. At the same time, the area occupation ratio of the second positive electrode active material on the surface of the positive electrode mixture layer, i.e., the surface in contact with the non-aqueous electrolyte, is increased to suppress the contact between the first positive electrode active material, which is a lithium composite oxide with a layered structure having the high energy density and the non-aqueous electrolyte, thus ensuring security. Therefore, a positive electrode for a lithium ion secondary battery with both high energy density and security can be achieved.

In particular, the average secondary particle diameter of the first positive electrode active material is set 9 μm or more and 15 μm or less, and the average secondary particle diameter of the second positive electrode active material is set to be smaller than the average secondary particle diameter of the first positive electrode active material, for example, 2 μm or more to 8 μm or less, the area occupation ratio of the second positive electrode active material on the surface of the positive electrode mixture layer can further be increased.

According to the first embedment, with a structure of a single positive electrode mixture layer containing the first and second positive electrode active materials, conductive agent, and binder, the production efficiency can be significantly improved as compared to the positive electrode with a two layer positive electrode mixture layer as in the above-mentioned JP 2020-512669 A.

### Second Embodiment

The lithium ion secondary battery of the second embodiment includes the aforementioned positive electrode for the lithium ion secondary battery, a negative electrode capable of absorbing and releasing lithium ions, and a non-aqueous electrode. The lithium ion secondary battery further includes a separator interposed between the positive electrode and the negative electrode.

The negative electrode includes a negative electrode current collector and a negative electrode layer including a negative electrode active material formed on one or both surfaces of the negative electrode current collector.

There are no restrictions on the material used for the negative electrode current collector, but it is preferable to use metal. Specifically, copper, aluminum, nickel, stainless steel, titanium, and other alloys are examples. Among these, copper is preferred in terms of electronic conductivity and battery operating potential.

The negative electrode active material is not restricted and can be selected from among metallic lithium, lithium alloys, carbon materials, conversion-based negative electrode, etc. Carbon materials are preferred from the viewpoint of price. Carbon materials include artificial graphite, natural graphite, meso carbon microbeads (abbreviated as MCMB), hard carbon, and soft carbon, etc. Among these, artificial graphite and natural graphite are preferred because of their higher capacity.

When the negative electrode active material is metallic lithium or lithium alloy, the negative electrode layer can be formed by attaching a foil of such metallic lithium or lithium alloy to one or both surfaces of the negative electrode current collector to fabricate the negative electrode.

On the other hand, when the negative electrode active material is materials other than metallic lithium or lithium alloy, for example, a carbon material, the negative electrode active material is dispersed in a solvent together with a binder and if necessary a conductive agent to prepare the negative electrode slurry. The negative electrode slurry can be applied to one or both surfaces of the negative electrode current collector, dried, and pressurized with a roller or the like as needed to form a negative electrode layer including the negative electrode active material and binders to fabricate the negative electrode.

The binder and the conductive agent in the negative electrode layer can be used the same as the binder and the conductive agent in the positive electrode mixture layer described in the first embodiment.

The non-aqueous electrolyte contains a non-aqueous solvent in which lithium salt is dissolved. Lithium salt is one selected from the group consisting of LiBF₄, LiPF₆, Li(FSO₂)₂N, Li(CF₃SO₂)₂N and the like, or a mixture of two or more of the above.

The non-aqueous solvent is not limited specifically, and may be one selected from the group consisting of dimethyl carbonate (DEC), diethyl carbonate (DEC), dipropyl carbonate (DPC), ethyl methyl carbonate (EMC), ethylene carbonate (EC), propylene carbonate (PC), methyl propionate, methyl acetate, methyl formate, methyl butyrate, dioxolane, 2-methyl tetrahydrofuran, tetrahydrofuran, dimethoxyethane, γ-butyrolactone, acetonitrile, and benzonitrile, or a mixture solvent containing two or more of the above. In particular, DMC, DEC, DPC, EMC, EC, and PC are preferred. Among them, it is preferable to include EC, which enables good film formation on the negative electrode active material.

It is preferable that the non-aqueous electrolyte further contains additives other than the above-mentioned lithium salt for the purpose of forming a high-quality film on the surface of the negative electrode active material by reductive decomposition during charging/discharging. The additives are not limited, but include, for example, vinylene carbonate, fluoroethylene carbonate, 1,3,2-dioxathiolane-2,2-dioxide (MMDS), 1,5,2,4-dioxadithiane-2,2,4,4-tetraoxide, phosphorous acid tris (trimethylsilyl), 1-propene-1,3-sultone, and Li₂PO₂F₂. Such additives may be used alone or in a mixture of two or more.

The separator can be, for example, a porous sheet formed of polymer or fiber, or a nonwoven separator. Furthermore, the separator may be a ceramic layer, which is a heat-resistant insulating layer, laminated to a porous substrate.

The positive electrode, negative electrode, separator, and non-aqueous electrolyte are stored in an outer casing. The outer casing is not limited, but can be, for example, a bag-like outer casing with a laminated film, coin-shaped metal can, cylindrical metal can, or rectangular metal can.

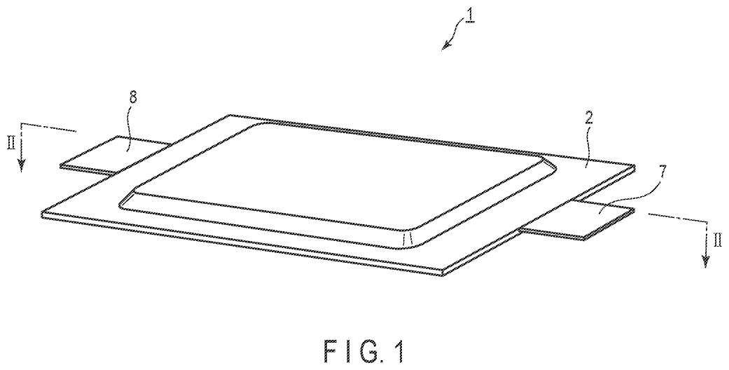

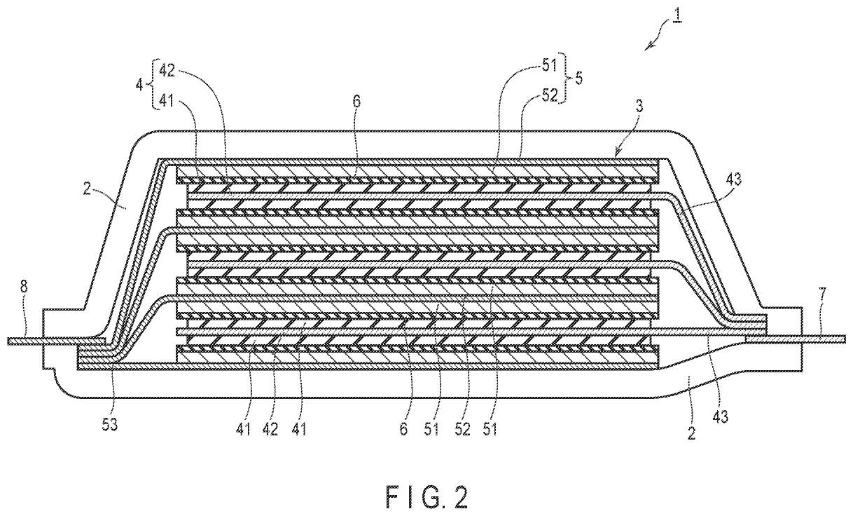

Hereinafter, the structure of a lithium-ion secondary battery of the second embodiment will be described with reference to the drawings, using a layered lithium-ion secondary battery as an example. FIG. 1 is a perspective view of an example of a layered lithium-ion secondary battery, and FIG. 2 is a cross-sectional view, taken along line II-II of FIG. 1.

The laminated lithium-ion secondary battery 1 includes a bag-shaped outer casing 2 formed of a laminate film. A flat electrode element 3 is stored inside the outer casing 2. The laminate film has a laminated structure, for example, with a plurality of plastic films (for example, two films) with a metal foil such as aluminum foil sandwiched therebetween. Of the two plastic films, one plastic film is a thermally bondable plastic film. The outer casing 2 includes the two laminate films stacked such that the thermally bondable plastic films face each other, an electrode element 3 interposed therebetween, and parts of the two laminate films thermally fused in the periphery of the electrode element 3 to for the sealing, thereby hermetically sealing the electrode element 3.

The electrode element 3 has a structure, as in FIG. 2, in which a positive electrode 4, a negative electrode 5, and a separator 6 interposed between the positive electrode 4 and the negative electrode 5 are layered for several sets with the negative electrode 5 located in the outermost layer. The positive electrode 4 includes a positive electrode current collector 42 and positive electrode mixture layer 41 and 41, which are formed on both surfaces of the current collector 42. The negative electrode 5, which is located at the outermost layer, includes a negative electrode current collector 52 and a negative electrode layer 51 formed of metallic lithium on the surface of the current collector 52 opposed to the separator 6. The negative electrode 5 located between positive electrode 4, except for the negative electrode 5 located at the outermost layer, includes the negative electrode current collector 52, and the negative electrode layer 51 and 51, which are formed of metallic lithium on both surfaces of the current collector 52.

The positive electrode 4 includes a positive electrode lead 43 which is a part of the positive electrode current collector 42 extending from, for example, the right side surface of the positive electrode mixture layer 41. Each positive electrode lead 43 is bundled at its tip within the outer casing 2 and joined to each other. A positive electrode terminal 7 has one end joined to the junction of the positive electrode leads 43 and extends out through the sealing portion of the outer casing 2 at the other end. The negative electrode 5 has a negative electrode lead 53 which is a part of the negative electrode current collector 52 extending from, for example, the left side surface of the negative electrode layer 51. Each negative electrode lead 53 is bundled at its tip within the outer casing 2 and joined to each other. The negative electrode terminal 8 is joined at one end to the junction of the negative electrode leads 53 and extends out through the sealing portion of the outer casing 2 at the other end.

As explained above, according to the second embodiment, with the aforementioned positive electrode of the first embodiment, a lithium ion secondary battery which can achieve both the high security and the high energy density can be presented.

### EXAMPLES

Examples will be cited below to further explain the present disclosure, but the present disclosure is not limited to the examples.

### Example 1

The first positive electrode active material, LiCo_{0.2}Ni_{0.5}Mn_{0.3}O₂ with an average secondary particle diameter of 10 μm (hereinafter referred to as NCM), and the second positive electrode active material, LiMn_{0.5}Fe_{0.5}PO₄ with an average secondary particle diameter of 7 μm (hereinafter referred to as LMFP) were mixed such that the weight ratio thereof becomes 70:30 (NCM:LMFP). The positive electrode active material was mixed with acetylene black (AB) and graphene as conductive agents, and polyvinylidene fluoride (PVDF) as the binder were mixed such that the weight ratio thereof becomes 90:3:3:4. The mixture was then dispersed in N-methyl-2-pyrrolidone (NMP) to prepare a positive electrode slurry. The positive electrode slurry was then applied to the surface of the aluminum foil which is the positive electrode current collector, dried, and pressed using a roll press to produce a positive electrode with the positive electrode mixture layer with a density of 2.5 g/cc.

The electrochemical properties were evaluated using a 2032-type coin-type lithium secondary battery (hereinafter referred to as coin cell) with the structure described below.

A lithium metal foil with a thickness of 300 μm was attached to the surface of a stainless steel foil negative electrode current collector with a 100 μm thickness to form the negative electrode layer, and the negative electrode was prepared.

Ethylene carbonate, ethyl methyl carbonate, and dimethyl carbonate were mixed in the ratio of 2:5:3 by volume, and the lithium salt LiPF₆ was dissolved therein at a ratio of 1.3 mol/L to prepare the non-aqueous electrolyte.

The resulting positive electrode, negative electrode, electrolyte, and separator with a microporous polyolefin membrane were used to manufacture a coin cell. Note that the coin cell was manufactured in an argon atmosphere with a dew point of −50° C. or lower.

### Example 2

The positive electrode was prepared through the same method as in Example 1 with the first positive electrode active material (NCM) and the second positive electrode active material (LMFP) as in Example 1 except for the weight ratio thereof (NCM:LMFP) was set to 80:20. Then, the coin cell was manufactured with the above positive electrode through the same method as in Example 1.

### Example 3

The positive electrode was prepared through the same method as in Example 1 with the first positive electrode active material (NCM) and the second positive electrode active material (LMFP) as in Example 1 except for the weight ratio thereof (NCM:LMFP) was set to 90:10. Then, the coin cell was manufactured with the above positive electrode through the same method as in Example 1.

### Comparative Example 1

The positive electrode was prepared through the same method as in Example 1 with the first positive electrode active material (NCM) and the second positive electrode active material (LMFP) as in Example 1 except for the weight ratio thereof (NCM:LMFP) was set to 60:40. Then, the coin cell was manufactured with the above positive electrode through the same method as in Example 1.

### Comparative Example 2

The positive electrode was prepared through the same method as in Example 1 with the first positive electrode active material (NCM) and the second positive electrode active material (LMFP) as in Example 1 except for the weight ratio thereof (NCM:LMFP) was set to 90:10, and the average secondary particle diameter of the first positive electrode active material was set to 5 μm and the average secondary particle diameter of the second positive electrode active material was set to 7 μm. Then, the coin cell was manufactured with the above positive electrode through the same method as in Example 1.

### Comparative Example 3

The positive electrode was prepared through the same method as in Example 1 except for the first positive electrode active material, LiCo_{0.2}Ni_{0.5}Mn_{0.3}O₂ (NCM) with an average secondary particle diameter of 10 μm was used as the positive electrode active material. Then, the coin cell was manufactured with the above positive electrode through the same method as in Example 1.

The positive electrodes incorporated in the obtained coin cells of Example 1 to 3 and Comparative examples 1 to 3 were examined using an EDS-equipped scanning electron microscope (JEOL, Inc., JSM-IT100) to check the surface condition. From the SEM image and EDS elemental mapping results, the area occupation ratio of LMFP (second positive electrode active material) on the surface of the positive electrode mixture layer (surface opposite to the surface in contact with the positive electrode current collector) was each measured. The results are shown in Table 1 below.

When the area occupation ratio of the second positive electrode active material on the surface of the positive electrode mixture layer is expressed a as a percentage, the weight ratio of the first positive electrode active material to the second positive electrode active material is 100−β:β(0<β<100), and the relationship between α and β is γ=β/α, the value of the parameter γ was calculated based on the area occupation ratio, and the proportion of the second positive electrode active material. The results are shown in Table 1 below.

Note that, the positive electrode incorporated in Comparative example 3 has only the first positive electrode active material in the positive electrode mixture layer, which is LiCo_{0.2}Ni_{0.5}Mn_{0.3}O₂ (NCM) with an average secondary particle diameter of 10 μm (NCM), and thus, the area occupation ratio of the second positive electrode active material (LMFP) and the value of the parameter γ are both zero.

Evaluation Test of Coin Cells

The coin cells of Examples 1 to 3 and Comparative examples 1 to 3 were each transferred to a thermostatic chamber set at 25° C. and an initial activation process of 5 cycles was performed. Charging and discharging conditions were performed as follows: charging at a constant current and constant voltage with current of 0.1 C, voltage of 4.2 V, and cutoff current of 0.05 C, and discharging at a constant current with 0.1 C and termination voltage of 2.75 V.

From the obtained charge-discharge curves, the mass energy density (Wh/kg) of the first positive electrode active material and the second positive electrode active material was calculated. The calculation method of the mass energy density is described below.

Energy Density (Wh/Kg)

=Average discharge voltage(V)×discharge capacity(Ah)/positive electrode active material mass(kg)

The results are shown in Table 1.

Assembly and evaluation test of lithium ion secondary battery

To confirm the security of the positive electrodes of Examples 1 to 3 and Comparative Examples 1 to 3, lithium-ion secondary batteries were manufactured. Note that, the negative electrode used in this test was designed to eliminate the effect of lithium melting at a high temperature of 200° C., and graphite was used as the active material of the negative electrode instead of metallic lithium.

That is, ten sheets of positive electrodes were prepared in the same way as in Example 1, and cut to the predetermined dimensions. Graphite as the negative electrode active material, acetylene black as the conductive agent, and polyvinylidene fluoride (PVDF) as the binder were mixed in a weight ratio of 97:1.5:1.5 (graphite:acetylene black:PVDF). The mixture was then dispersed in N-methyl-2-pyrrolidone (NMP) to prepare the negative electrode slurry. The negative electrode slurry was then applied to the surface of the copper foil used as the negative electrode current collector, dried, and pressed using a roll press to produce a negative electrode layer has negative electrode mixture layer with a density of 1.2 g/cc. Eleven sheets of the resulting negative electrode were prepared, and each were cut to a predetermined dimension. Then, ten bag-shaped separators were prepared, and ten pieces of positive electrodes cut to a predetermined dimension were each contained in each bag-shaped separator. The bag-shaped separators which containing the positive electrode, and the negative electrode were then alternately stacked so that the negative electrodes were positioned on the bottom and top layers to obtain a layered electrode group. In the resulting layered electrode group, terminal tabs were each connected by ultrasonic welding to the unformed parts of positive electrode mixture layer of the positive electrode and the unformed parts of negative electrode mixture layer of the negative electrode.

Next, a bag-shaped outer casing including two laminate films was prepared. Each laminate film has a structure in which an aluminum foil is interposed between a thermally bondable resin film and a polyethylene terephthalate film. One laminate film is provided with a recess by, for example, a drawing process, while the other laminate film has a flat shape. The layered electrode group with tabs were stored in the recesses of one laminated film such that the terminal tabs protrude to the outside, the flat-shaped other laminated film is then overlaid on one laminated film such that the thermally bondable resin films are in contact with each other. The three peripheral edges are then heat-fused to each other, thereby storing the layered electrode group with tabs in the outer casing. The non-aqueous electrolyte is injected from one of the sides of the outer casing left unsealed, and it was vacuum-sealed to assemble the lithium-ion battery (5 Ah class laminated cell) in a sealed state. The non-aqueous electrolyte was a mixture solvent of ethylene carbonate, ethyl methyl carbonate, and dimethyl carbonate in the ratio of 2:5:3 by volume, with lithium salt LiPF₆ dissolved at a ratio of 1.3 mol/L.

In addition, for Examples 2 and 3 and Comparative Examples 1 to 3, except for the use of the respective positive electrode, 5 Ah class laminate cells were assembled through the aforementioned method.

The 5 Ah class laminate cells of Examples 1 to 3 and Comparative examples 1 to 3 were used for a heating limit test. The heating limit test was conducted with the lithium ion secondary batteries (Examples 1 to 3 and Comparative examples 1 to 3) at an upper voltage limit of 4.2 V and SOC of 100%, which were heated at a temperature of 200° C. at a rate of 10° C./min, and held for 3 hours. Security was judged as “×” for ignition and “◯” for no ignition in the heating limit test. The results are shown in Table 1 below.

The first positive electrode active material (lithium composite oxide with a layered structure, e.g., NCM) generates, when the material is in contact with the non-aqueous electrolyte, oxygen by the decomposition of the non-aqueous electrolyte because the decomposition reaction of the electrolyte proceeds gradually when the electrolyte is under potential. Furthermore the decomposition of the non-aqueous electrolyte is accelerated at high temperatures. If oxygen is generated at high temperatures, ignition may occur. This makes it impossible to guarantee security. Therefore, a second positive electrode active material (thermally stable polyanionic compound, e.g., LMFP) is added greater to the surface of the positive electrode mixture layer opposite to the surface in contact with the positive electrode current collector in order to effectively suppress the oxygen generation.

TABLE 1

| | | NCM | LMFP | | | | | |
|---|---|---|---|---|---|---|---|---|
| | | average | average | Area | | | | |
| | | secondary | secondary | occupation | | | | |
| | | particle | particle | ratio (α) | | Energy | | |
| | Mixture ratio | diameter | diameter | of LMFP | | density | | Overall |
| | (100-β:β) | (μm) | (μm) | (Percentage) | γ (=β/α) | (Wh/kg) | Security | evaluation |
| Example 1 | NCM:LMFP = 70:30 | 10 | 7 | 35.88 | 0.84 | 568.74 | ∘ | ∘ |
| Example 2 | NCM:LMFP = 80:20 | 10 | 7 | 31.27 | 0.64 | 567.94 | ∘ | ∘ |
| Example 3 | NCM:LMFP = 90:10 | 10 | 7 | 30.17 | 0.33 | 615.45 | ∘ | ∘ |
| Comparative | NCM:LMFP = 60:40 | 10 | 7 | 41.01 | 0.98 | 520.12 | ∘ | x |
| Example 1 | | | | | | | | |
| Comparative | NCM:LMFP = 90:10 | 5 | 7 | 11.02 | 0.91 | 619.21 | x | x |
| Example 2 | | | | | | | | |
| Comparative | NCM:LMFP = 100:0 | 10 | — | 0 | 0 | 626.07 | x | x |
| Example 3 | | | | | | | | |

As is apparent from Table 1 above, when the positive electrode mixture layer contains a mixture of the first and second positive electrode active materials, wherein the average secondary particle diameter of the first positive electrode active material is r1 and the average secondary particle diameter of the second positive electrode active material is r2, and the relationship r1>r2 is satisfied, and wherein the area occupation ratio of the second positive electrode active material on the surface of the positive electrode mixture layer is expressed as a in percentage, the weight ratio of the first positive electrode active material to the second positive electrode active material is 100−β:β (0<β<100), and the relationship between α and β is γ=β/α, it is understood that the coin cells of Examples 1 to 3 with the positive electrodes with γ values 0.33 or more and 0.84 or less are all able to ensure high security and high energy density.

In contrast, the coin cell of Comparative example 1 in which the positive electrode mixture layer contains a positive electrode active material which is a mixture of the first and second positive electrode active materials, and the average secondary particle diameters of the first and second positive electrode active materials are r1 and r2, the relationship r1>r2 is satisfied, but the γ value of the parameter is 0.98 which exceeds the upper limit of a range between 0.33 and 0.84 can ensure the high security but fails to ensure the high energy density.

Furthermore, the coin cell of Comparative example 2 in which the positive electrode mixture layer contains a positive electrode active material which is a mixture of the first and second positive electrode active materials, and the average secondary particle diameters of the first and second positive electrode active materials are r1 and r2, the relationship is r1<r2, and the γ value of the parameter is 0.91 which exceeds the upper limit (0.84) of the above range can ensure the high energy density but fails to ensure the security.

The coin cell of Comparative example 3 with the positive electrode including a positive electrode mixture layer containing NCM which is the first positive electrode active material with the average secondary particle diameter of 10 μm can ensure the high energy density but fails to ensure the security much less than the coin cell of Comparative example 2. This is because the surface of the positive electrode mixture layer in contact with the non-aqueous electrolyte is a lithium composite oxide (e.g., NCM) with a layered structure, when contact with non-aqueous electrolyte, which generates oxygen through decomposition of the non-aqueous electrolyte and may cause ignition at high temperatures (200° C. or higher).

What is claimed is:

1. A positive electrode for a lithium ion secondary battery comprising a positive electrode current collector and a positive electrode mixture layer formed on one surface or both surfaces of the positive electrode current collector, wherein
the positive electrode mixture layer contains a positive electrode active material, conductive agent, and a binder,
the positive electrode active material is a mixture of a first positive electrode active material which is a lithium composite oxide with a layered structure and a second positive electrode active material which is a polyanionic compound with an olivine type structure, an average secondary particle diameter of the first positive electrode active material is r1, and an average secondary particle diameter of the second positive electrode active material is r2, a relationship r1>r2 is satisfied, and
when an area occupation ratio of the second positive electrode active material on the surface of the positive electrode mixture layer is a in percentage, and a weight ratio of the first positive electrode active material and the second positive electrode active material is given 100−β:β (0<β<100), and a relationship of the α and the β is γ=β/α, the γ is 0.33 or more and 0.84 or less.

2. The positive electrode for the lithium ion secondary battery of claim 1, wherein the lithium composite oxide with a layered structure which is the first positive electrode active material is represented by a general formula LiaM1O2, where M1 is one or more transition metals selected from the group consisting of Co, Ni, Mn, and Al, and a is 0.9≤a≤1.1.

3. The positive electrode for the lithium ion secondary battery of claim 1, wherein the polyanionic compound with an olivine type structure which is the second positive electrode active material is represented by a general formula LibM2O4, where M2 is one or more transition metal selected from the group consisting of Fe and Mn, and b is 0.9≤b≤1.1.

4. The positive electrode for the lithium ion secondary battery of claim 2, wherein the polyanionic compound with an olivine type structure which is the second positive electrode active material is represented by a general formula LibM2O4, where M2 is one or more transition metal selected from the group consisting of Fe and Mn, and b is 0.9≤b≤1.1.

5. The positive electrode for the lithium ion secondary battery of claim 1, wherein the average secondary particle diameter (r1) of the first positive electrode active material is 9 μm or more and 15 μm or less, and the average secondary particle diameter (r2) of the second positive electrode active material is smaller than r1.

6. The positive electrode for the lithium ion secondary battery of claim 2, wherein the average secondary particle diameter (r1) of the first positive electrode active material is 9 μm or more and 15 μm or less, and the average secondary particle diameter (r2) of the second positive electrode active material is smaller than r1.

7. The positive electrode for the lithium ion secondary battery of claim 3, wherein the average secondary particle diameter (r1) of the first positive electrode active material is 9 μm or more and 15 μm or less, and the average secondary particle diameter (r2) of the second positive electrode active material is smaller than r1.

8. A lithium ion secondary battery comprising the positive electrode for the lithium ion secondary battery of claim 1, a negative electrode which is capable of absorbing and releasing lithium ions, and non-aqueous electrolyte.

9. A lithium ion secondary battery comprising the positive electrode for the lithium ion secondary battery of claim 2, a negative electrode which is capable of absorbing and releasing lithium ions, and non-aqueous electrolyte.

10. A lithium ion secondary battery comprising the positive electrode for the lithium ion secondary battery of claim 3, a negative electrode which is capable of absorbing and releasing lithium ions, and non-aqueous electrolyte.

11. A lithium ion secondary battery comprising the positive electrode for the lithium ion secondary battery of claim 4, a negative electrode which is capable of absorbing and releasing lithium ions, and non-aqueous electrolyte.

12. A lithium ion secondary battery comprising the positive electrode for the lithium ion secondary battery of claim 5, a negative electrode which is capable of absorbing and releasing lithium ions, and non-aqueous electrolyte.
